(19) United States
(12) Patent Application Publication
(10) Pub. No.: US 2009/0235564 A1
(43) Pub. Date: Sep. 24, 2009

(54) Greeting card holder with display support member

(76) Inventor: Timothy B. Hummel, Oklahoma City, OK (US)

Correspondence Address: MCAFEE & TAFT;TENTH FLOOR, TWO LEADERSHIP SQUARE, 211 NORTH ROBINSON, OKLAHOMA CITY, OK, 73102, US

(21) Appl. No.: 12/077,759

(22) Filed: Mar. 21, 2008

(51) Int. Cl. G09F 1/10

(52) U.S. Cl. 40/124.4

(57) ABSTRACT

The current invention provides a card holder for displaying a card on a flat horizontal surface. The card holder is substantially adhesive free and can be mailed in a flat configuration with a greeting card in a greeting card envelope. The card holder comprises a panel having tabs that are extendable outwardly from the panel and arranged in a pattern to secure the edges of the card, thus allowing the card to be displayed in a stable manner. The card holder may have a display member that extends to further support a card being displayed.

### BACKGROUND

This invention relates to an improved device for holding and displaying a single greeting card or the like. In particular, the current invention provides a mailable card holder suitable for displaying cards folded either vertically or horizontally.

Greeting cards are exchanged year round but are especially popular at Christmas. Recipients often display the cards by stacking them in a tray or bowl, by attaching them to a wall using ribbons, tacks, tape or glue, or by standing them upright on a flat surface such as a table top or mantel.

Each of these display methods suffer from shortcomings. The stacking approach requires handling of the cards to view them. Attaching the cards to a wall leaves marks on the wall and precludes close examination of the cards. Finally, cards standing upright on a surface are easily knocked over.

Therefore, a need exists for a small, economical, and disposable device for displaying greeting cards which overcomes the problems described above.

### SUMMARY

The present invention provides a method and device for holding and displaying a card such as a greeting card. The card holder can be mailed in a flat configuration with a greeting card in a greeting card envelope. The size and weight of the card holder is preferably equal to or less than the greeting card. The holder may be configured to display a card having a horizontal fold in an upright tent position. Additionally, the holder may be configured to display a card having a vertical fold in an upright book position. Finally, if the card is not folded, then the holder may be configured to display the card in an upright position.

In one embodiment, the card holder of the present invention comprises a panel, preferably a single piece of paperboard stock or bendable light plastic. The panel preferably comprises a plurality of opposing tabs which may be bent outwardly from the panel. The tabs are aligned such that when the panel is lying on a horizontal surface, the outwardly extending tabs securely retain one or more bottom edges of the greeting card. When the tabs are oriented in a V pattern, the card holder can secure a card in a book orientation. When the tabs are oriented in two or more parallel lines, the card holder can secure a card in a tent configuration. Preferably, the card holder can accommodate a card in either a tent or book position.

In another embodiment, the current invention provides a greeting card holder comprising a panel which carries a card supporter having at least two sidewalls defining a V. The V is suitable for receiving the folded edge of a greeting card thereby providing support for the greeting card. Additionally, the card supporter may be folded to a substantially flat position.

The present invention also provides a method for displaying greeting cards, picture/photo cards, photographs, and other long or short card-like devices comprising the following steps. According to the method of the current invention, a flat panel prepared from a suitable paper stock or plastic is cut to a desired configuration suitable for supporting the card to be displayed. Subsequently, tabs are severably scored into the panel. Optionally, the portion of the tab securing the tab to the panel may be lightly scored to aid in flexing of the tab. Thereafter, the desired tabs are pushed outwardly from the panel. The tabs are bent along the intact edge retaining the tab to the panel in a manner suitable for engaging a card. Following positioning of the desired tabs, a greeting card is positioned on the card holder for display.

The foregoing and other advantages and features of the present invention will become apparent upon reading the following detailed description in conjunction with the accompanying drawings.

### BRIEF DESCRIPTION OF THE DRAWINGS

FIG. 1A is a perspective view of one embodiment of the current invention.

FIG. 1B is a perspective view of a card displayed in a tent configuration on the device depicted in FIG. 1A.

FIG. A is a perspective view of a panel scored for pairs of tabs.

FIG. 2B depicts a pair of tabs wherein a single scoring forms adjacent side edges of each tab.

FIG. 2C depicts a pair of tabs wherein a single scoring forms the top edges of each tab in the pair of tabs.

FIG. 2D depicts a pair of tabs with a card edge positioned between the tabs of the embodiment of FIG. 2A.

FIG. 3A is a perspective view of a panel scored for a plurality of opposing tabs.

FIG. 3B depicts an enlarged view of a tab cluster.

FIG. 3C depicts an alternative embodiment of the tab cluster.

FIG. 4A is a perspective view of one embodiment of the current invention.

FIG. 4B is a perspective view of a card displayed in a book configuration on the device of this invention.

FIG. 4C is a perspective view of a card holder capable of displaying a card in more than one configuration.

FIG. 5A is a perspective view of another embodiment of the current invention.

FIG. 5B is a perspective view of a postcard displayed on the embodiment of FIG. 5A.

FIG. 5C is a perspective view of a display support member embodiment.

FIG. 5D is a perspective view of a photo card displayed by the embodiment of FIG. 5C.

FIG. 5E is a perspective view of an alternative display support member embodiment prior to configuring for supporting a photo card.

FIG. 5F is a perspective view of a photo card displayed by the embodiment of FIG. 5E.

FIG. 6A is a perspective view of another embodiment of the current invention.

FIG. 6B is a perspective view of a card displayed on the embodiment of FIG. 6A.

### DETAILED DESCRIPTION

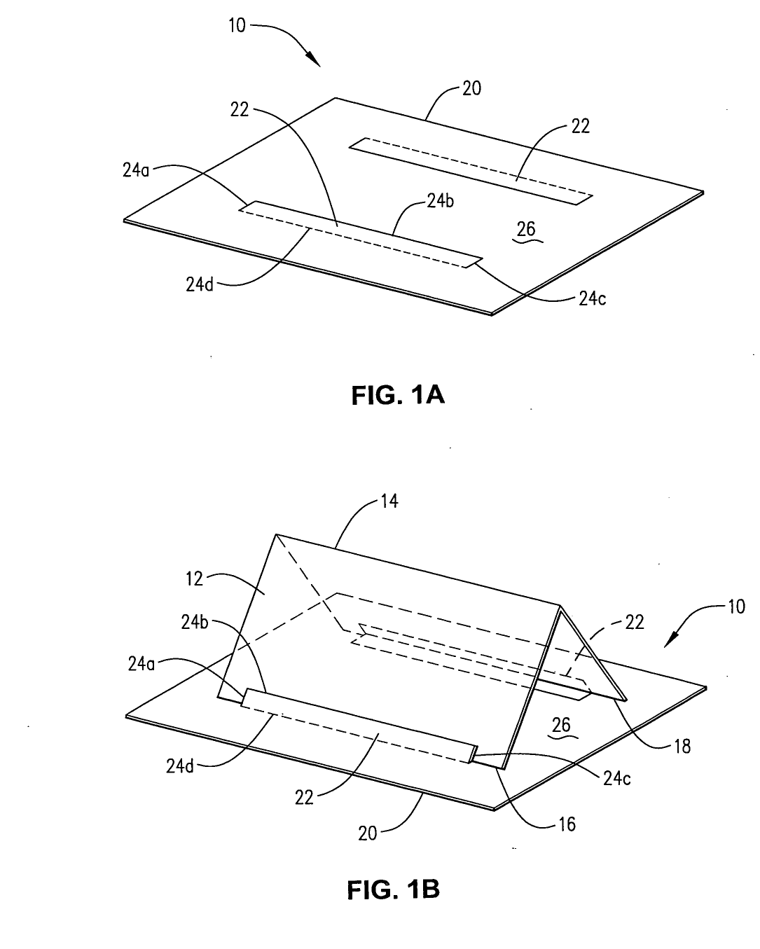

FIGS. 1A through 4C depict preferred embodiments of the current invention. In the embodiment of FIG. 1A, a card holder 10 comprises a panel 20 having at least two parallel severably scored tabs 22. Tabs 22 are severably scored on three edges 24a, 24b, 24c. Tab 22 is optionally lightly scored on edge 24d to aid in flexing of tab 22 to an outward position as depicted in FIG. 1B.

As used herein, the term “severably scored” includes perforations, cuts or other similar localized breakaway mechanisms completely or substantially through panel 20, which permit separation of edges 24a, 24b, 24c from panel 20 by application of force. Preferably, one would be able to move severably scored tab 22 by slight application of pressure with a finger. Edge 24d can be made totally by movement of tab 22 or this portion of tab 22 can be lightly scored to assist in the bending or folding of tab 22. Light scoring is especially useful when tab 22 is elongated as in FIGS. 1A and 1B.

FIG. 1B depicts card holder 10 displaying a greeting card 12 in a tent position. Greeting card 12 has a horizontal fold 14 and first and second edges 16 and 18. In this embodiment, tab 22 restricts movement of card 12 precluding card 12 from collapsing under its own weight. Thus, card holder 10 provides the ability to display card 12 in a tent configuration without the use of separate retaining devices.

In a preferred embodiment, card holder 10 is configured from a panel 20. Panel 20 can be constructed of any lightweight material capable of being scored and bent or folded. Preferably, panel 20 is constructed of paperboard stock or plastic. Non-limiting examples of suitable paperboard stock include tag board, letter paper stock, card stock, card board, kraft paper and the like. In general, the material used to construct card holder 10 should be a single sheet which retains a desired configuration following bending. Thus, following bending, tabs 22 will remain extended from panel 20.

Panel 20 can be manufactured and/or sold with greeting card 12. Panel 20 is flat and lightweight and therefore easily mailed with card 12 in the card envelope (not shown). Panel 20 can optionally be decorated to match or complement card 12 such that the overall appearance of displayed card 12 and card holder 10 is pleasing to a viewer. Panel 20 is also quickly and easily converted to card holder 10 by pushing tabs 22 outward from panel surface 26 and folding or bending the unsevered edge 24d such that tab 22 maintains its extended position. Preferably, card holder 10 has a size less than or equal to card 12 to be displayed. Further, card holder 10 preferably has a weight equal to or less than the weight of card 12.

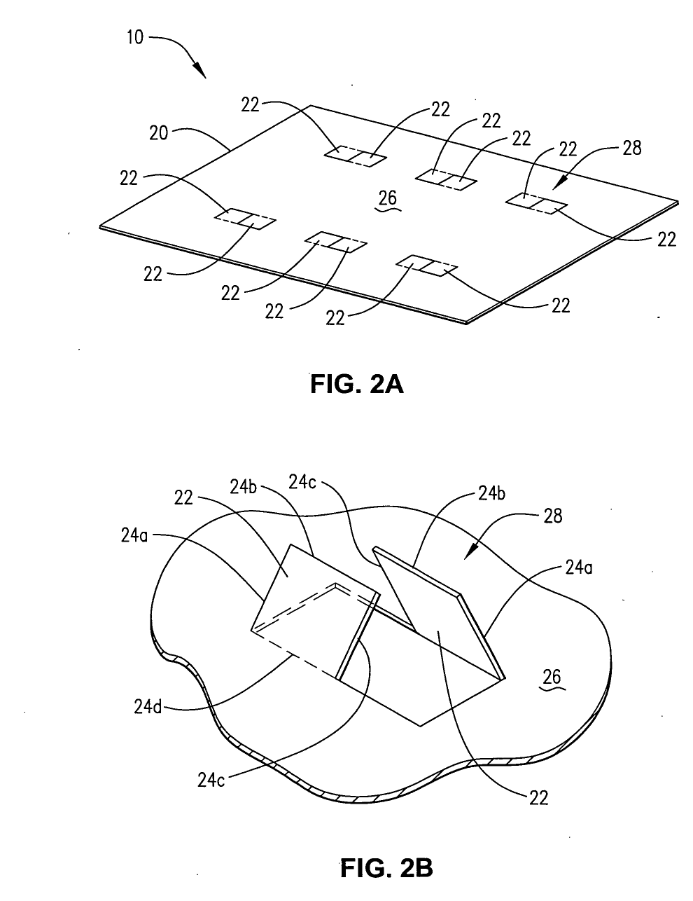

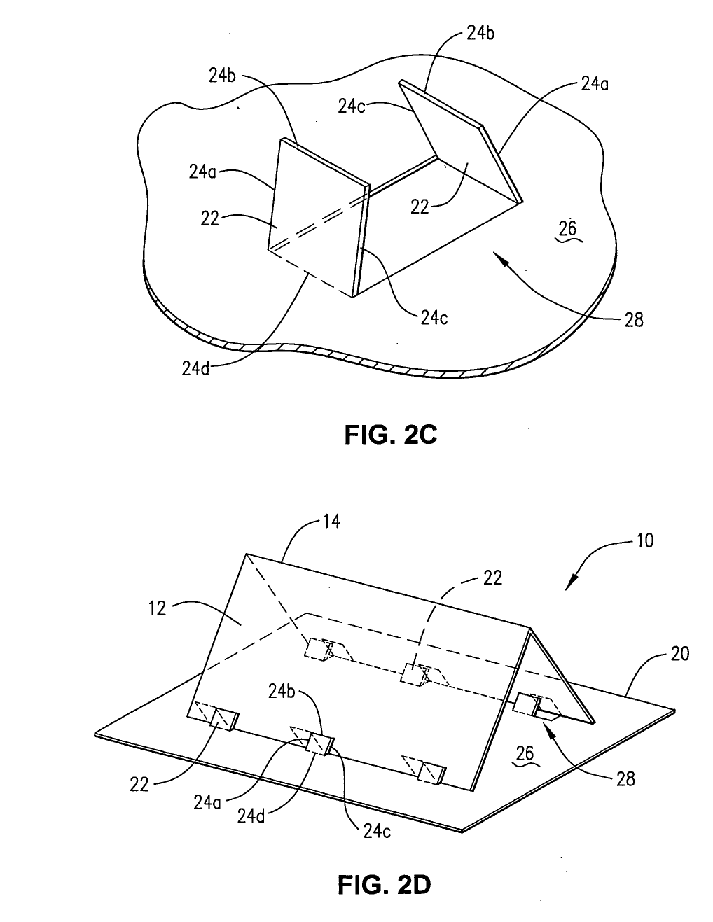

It is sometimes desirable to more securely retain card edges 16, 18. With reference to FIG. 2A, one embodiment of the current invention provides a panel 20 having pairs of opposing tabs 22. As shown in FIG. 2B, tab pairs 28 comprise tabs 22 partially extend from surface 24 of panel 20 at acute angles by raising edges 24a, 24b, 24c and bending at edge 24d. Tab pairs 28 are aligned in parallel lines or rows in a manner suitable for securing card edges 16 and 18 when greeting card 12 is displayed in a tent position, as in FIG. 1A. As depicted in FIG. 2B, edge 24d of one tab 22 does not contact the corresponding edge 24d of the other tab 22 in tab pair 28. In the embodiment depicted, edges 24c of each tab 22 are prepared by a single scoring of panel 20. However, the current invention also contemplates an arrangement of tab pairs 28 wherein edges 24b of each tab 22 are prepared by a single scoring of panel 20. This embodiment is depicted in FIG. 2C.

In either format, tabs 22 are bent outward from panel 20 at an angle appropriate to engage greeting card 12 positioned on card holder 10. Preferably, opposing top tab edges 24b engage each side of card edges 16, 18 as depicted in FIG. 2D. By positioning tabs 22 on each side of card edge 16 or 18, this embodiment provides additional stability to greeting card 12.

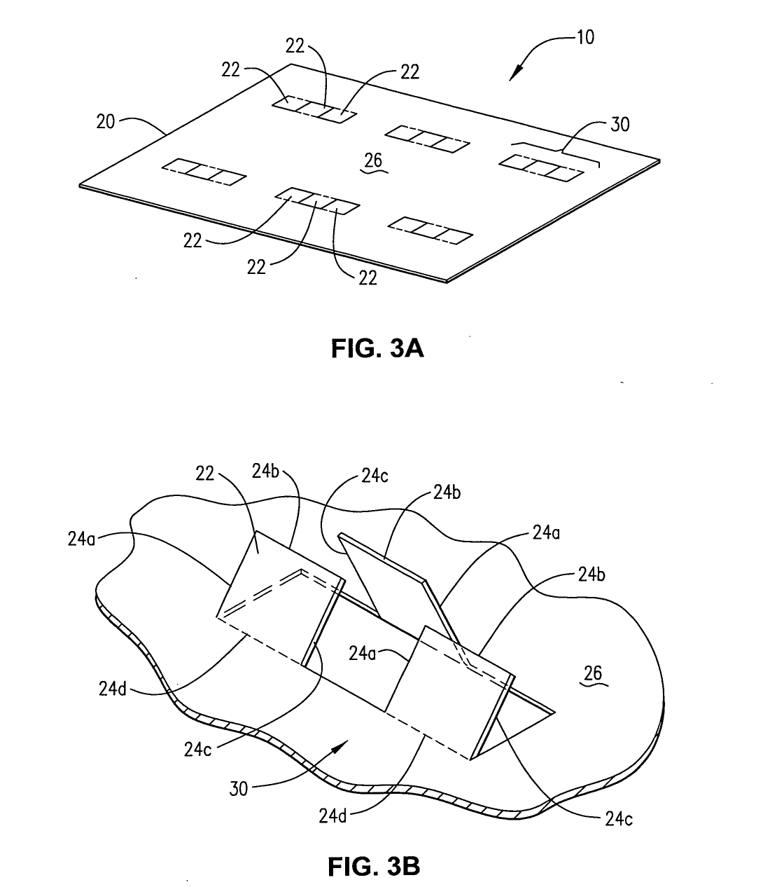

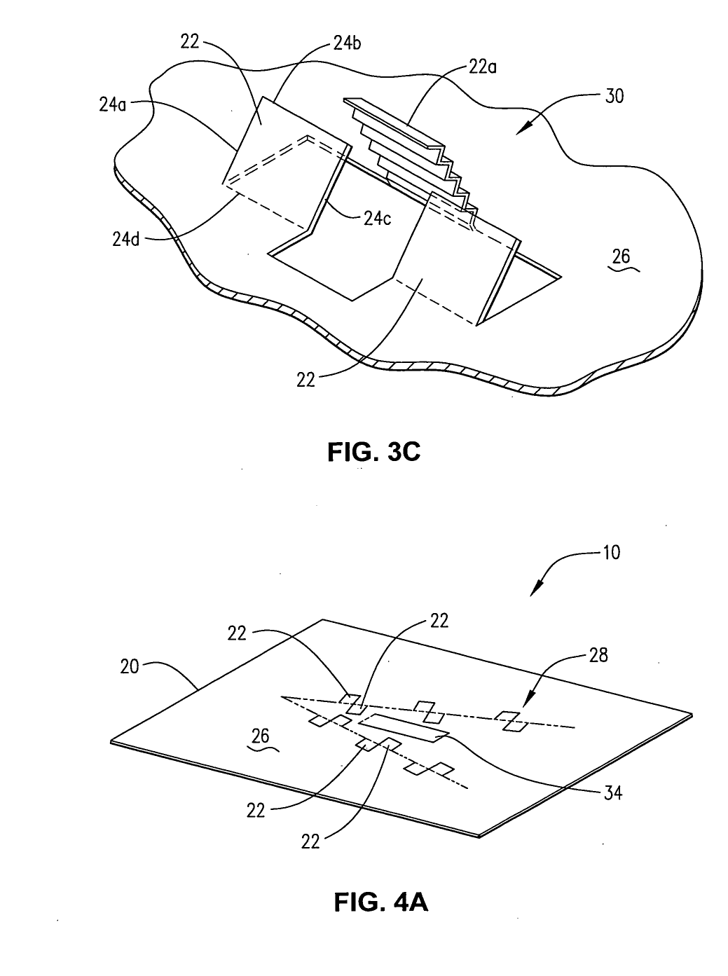

With reference to FIGS. 3A and 3B, tabs 22 can be arranged in pairs 28 or in clusters 30 of three or more. FIG. 3A shows a panel 20 with parallel lines of tab clusters 30 wherein each tab cluster 30 comprises three tabs 22. However, cluster 30 may comprise any number of tabs 22. Tab clusters 30 are particularly useful for displaying unfolded cards 12 such as business cards (not shown).

FIG. 3C schematically shows a variation wherein the middle tab 22a of three-tab cluster 30 is folded or kinked in accordion fashion. It is believed that providing one or more accordion folded tabs 22a to tab cluster 30 improves the gripping action of tab clusters 30. Tabs 22a to be folded in accordion fashion are preferably longer than tabs 22. Preferably, accordion fold lines 32 are marked or lightly scored onto tabs 22a.

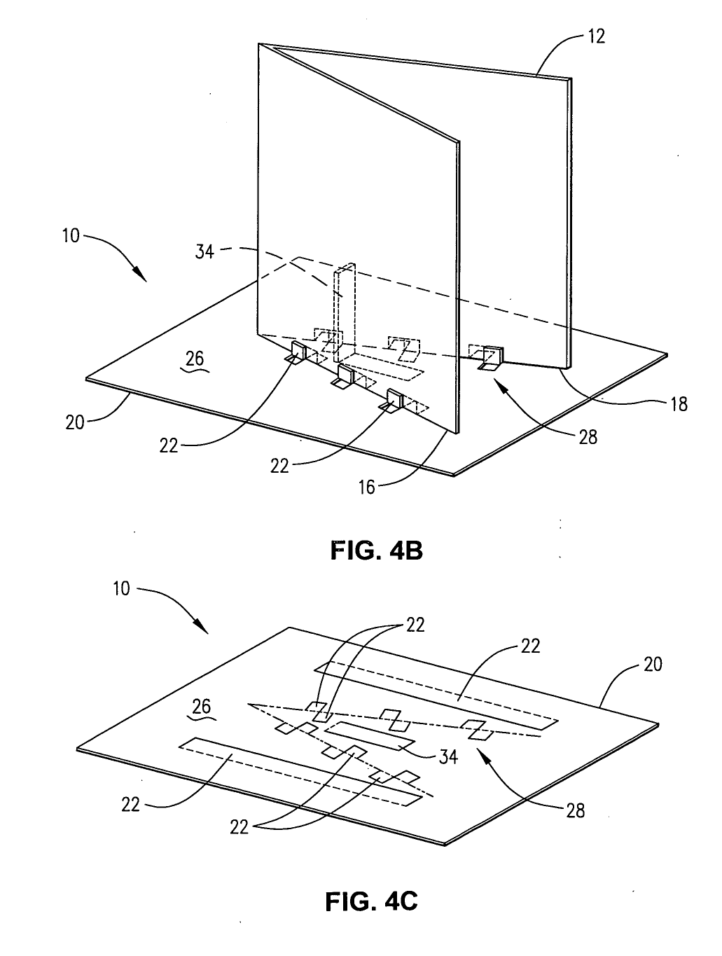

FIG. 4A depicts another embodiment of the current invention. This embodiment comprises panel 20 with a series of tabs 22 arranged in a V-shaped configuration. As noted above, tabs 22 are severably scored into panel 20. When extended from panel 20, tabs 22 engage card 12 placed on card holder 10. In a preferred embodiment, at least one tab 22 is positioned on each side of card edges 16 and 18. More preferably, as shown in FIG. 4B, at least two tabs 22 are positioned on either side of card edges 16 and 18. Optionally, a stabilizing tab 34 is carried by panel 20 in the gap formed by the V-shaped arrangement of tabs 22. Stabilizing tab 34 preferably has a length equal to at least half of the height of card 12 when displayed in a book position. Stabilizing tab 34 is severably scored in the manner of tabs 22. Although not depicted in FIGS. 1A and 1B, stabilizing tab 34 may be incorporated into the embodiment depicted therein. As depicted in FIG. 4B, stabilizing tab 34 provides additional support to card 12.

FIG. 4B depicts card holder 10 displaying greeting card 12 in a book position. Greeting card 12 has a vertical fold 14 and first and second edges 16 and 18. Cards 12 placed in this position without a holder usually fall over when touched, brushed against, or subjected to even slight air movement. This embodiment of card holder 10 improves the stability of card 12 when displayed in a book position. In this embodiment, card holder 10 provides a wide, secure base for card 12. Tab pairs 28 or clusters 30 secure edges 16 and 18 of card 12, thus maintaining an upright position and effectively integrating card holder 10 with card 12.

Referring to FIG. 4C, another preferred embodiment comprises card holder panel 20 having parallel elongated tabs 22, tab pairs 28 or tab clusters 30 (tab clusters 30 not shown in FIG. 4C) capable of displaying and providing support to card 12 in a tent position, as well as tab pairs 28 or clusters 30 arranged in a V pattern capable of displaying and providing support to card 12 in a book position.

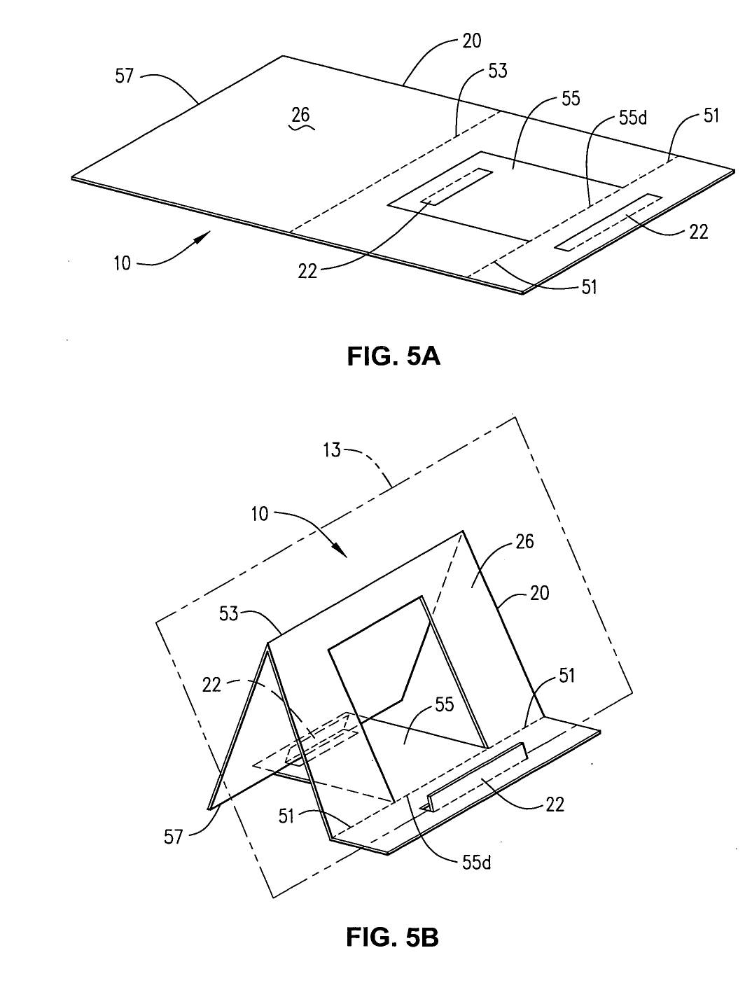

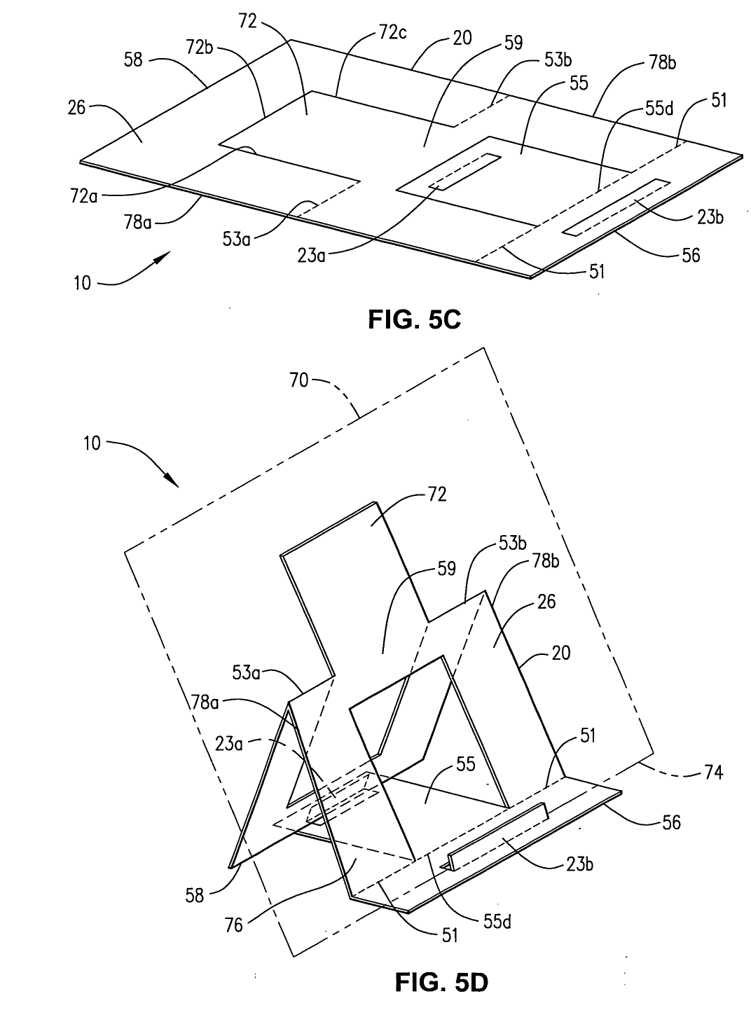

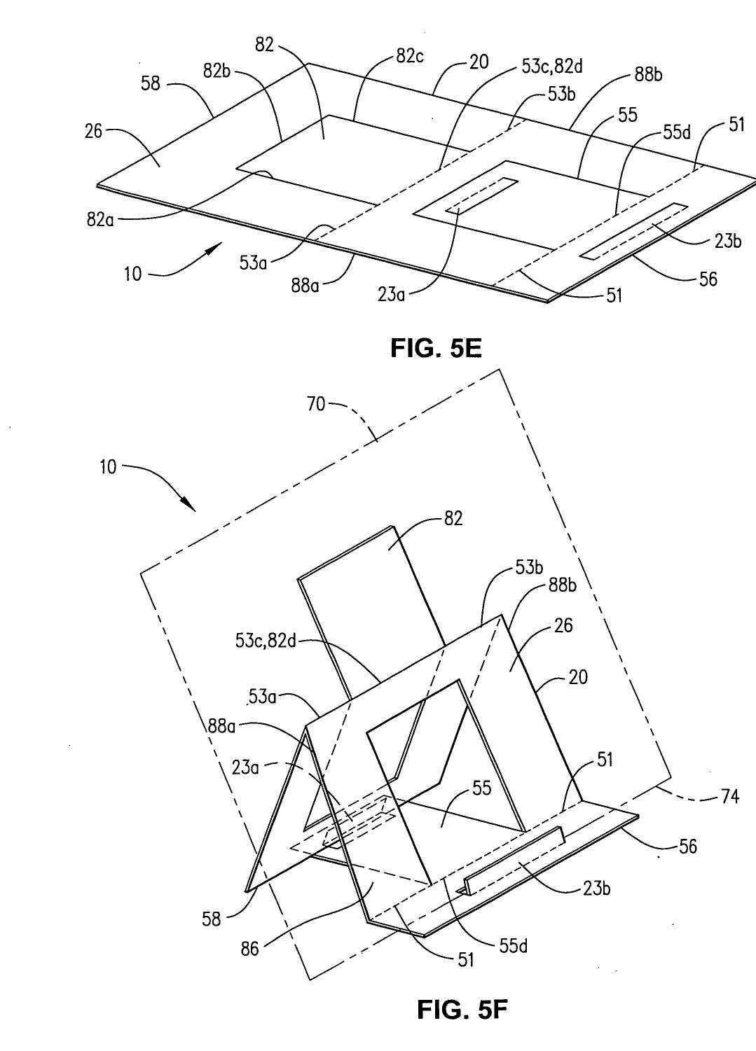

FIG. 5A depicts another preferred embodiment of the current invention. Card holder 10 depicted in FIG. 5A is suitable for displaying greeting cards in the tent position and for displaying postcards 13 or other cards which do not incorporate a fold in their design. As depicted in FIG. 5A, panel 20, used to form this embodiment of card holder 10, preferably has two pre-folded or lightly scored lines 51 and 53. A base tab 55 is severably scored into panel 20 in a manner similar to tabs 22 described above. Base tab 55 carries at least one severably scored tab 22. At least one additional severably scored tab 22 is positioned adjacent to the secured edge 55d of base tab 55.

When positioned as depicted in FIG. 5B, card holder 10 provides a support for displaying postcard 13. As depicted, panel 20 is bent along pre-folded lines 51 and 53. Base tab 55 is separated from panel 20 and lies adjacent to the surface (not shown) supporting panel 20. Tab 22 carried by base tab 55 is bent upwards in manner sufficient to engage and retain edge 57 of panel 20. Following engagement of edge 57 with tab 22 carried by base tab 55, card holder 10 is ready to display a post card 13 or other similar card lacking a fold. When displaying a postcard 13, tab 22 adjacent to edge 55d retains lower edge 13a of postcard 13 while card holder 10 presents postcard 13 at an angle suitable for viewing.

A preferred embodiment with a display support member is depicted in FIGS. 5C and 5D. Card holder 10 depicted in FIGS. 5C and 5D is capable of displaying greeting cards, picture/photo cards, photographs, and other long or short card-like devices. The displaying may be in the vertical or horizontal orientation of the item being displayed. In FIG. 5D, card 70 is shown displayed on card holder 10.

FIG. 5C depicts panel 20 in a flat state. As shown, panel 20 has one completely pre-folded or lightly scored seam 51, and two lightly scored seams 53a and 53b. Seams 53a and 53b are separated by an unscored and unaltered segment 59 of panel surface 26 and display support member 72. Combined, seams 53a, 53b and segment 59 substantially cross between edges 78a and 78b of panel 20. Seam 51 forms a movable or flexible joint in panel 20. Seams 53a and 53b form a second and third movable or flexible joint near the middle of panel 20.

Base tab 55, severably scored tabs 23a and 23b, and display support member 72 are carried by panel 20. A first severably scored tab 23a is carried on base tab 55. A second severably scored tab 23b is carried by panel 20 and is positioned between secured edge 55d of base tab 55 and panel edge 56. Display support member 72 has severably scored edges 72a, 72b, and 72c. Segment 59 is the portion of display member 72 that coincides with panel 20 at seams 53a and 53b, and is not meant to be bent, moved or removed.

Referring to FIGS. 5C and 5D, to assemble holder 20, base tab 55 is separated from panel 20 and positioned adjacent to and substantially parallel to a surface (not shown). As depicted, panel 20 is bent along seams 51, 53a and 53b. Tab 23a carried by base tab 55 is bent upwardly from base tab 55. Final assembly places end 58 in engagement with tab 23a carried by base tab 55. Tab 23b, not carried by base tab 55, is bent upwardly from panel 20 to support card 70 at its lower edge 74 at an angle suitable for viewing. Preferably, tabs 23a and 23b are parallel to each other. In this configuration, card holder 10 is ready to display card 70. Thus, when configured to support card 70, display member 72 is not bent. Rather, display member 72 merely externally projects outwardly and separate from panel 20.

FIG. 5D depicts card holder 10 assembled to display card 70. As assembled, panel surface 26 of card holder 10 forms card holder front 76 upon which card 70 rests when displayed while edge 74 of card 70 is retained by tab 23b. In the display position depicted in FIG. 5D, display member 72 extends in an upward direction along a similar plane as card holder front 76.

An alternative preferred embodiment is depicted in FIGS. 5E and 5F with a display support member. Card holder 10 depicted in FIGS. 5E and 5F is capable of displaying greeting cards, picture/photo cards, photographs, and other long or short card-like devices. The displaying may be in the vertical or horizontal orientation of the item being displayed. In FIG. 5F, photo card 70 is shown displayed on card holder 10.

FIG. 5E depicts panel 20 in a flat state. Panel 20 has one completely pre-folded or lightly scored seam 51, and two lightly scored seams 53a and 53b. Seams 53a and 53b form a seam separated by severably scored line 53c that is positioned between panel surface 26 and display support member 82. Combined, seams 53a, 53b and 53c substantially cross between edges 88a and 88b of panel 20. Base tab 55, severably scored tabs 23a and 23b, and display support member 82 are carried by panel 20. A first severably scored tab 23a is carried on base tab 55. A second severably scored tab 23b is carried by panel 20 and is positioned between secured edge 55d of base tab 55 and panel edge 56. Seam 51 forms a movable or flexible joint in panel 20. Seams 53a and 53b form a second and third movable or flexible joint near the middle of panel 20.

Display support member 82 has severably scored edges 82a, 82b, and 82c. Edge 82d is the point of display member 82 that coincides with panel surface 26 at seam 53c. Edge 82d and 53c are coincidental with each other. Edge 82d may be perforated or have some other means to assist a user in detaching it. For example, if advertising or coupons are optionally printed upon display member 82, then the user would be able to detach display member 82 for later use. The point of detachment is edge 82d. In one embodiment, display member 82 may also be a detachable business card. It is believed the detaching of display support member 82 will occur after the user is through with displaying card 70.

Referring to FIGS. 5E and 5F, to assemble holder 20, base tab 55 is separated from panel 20 and positioned adjacent to and substantially parallel to a surface (not shown). As depicted, panel 20 is bent along seams 51, 53a and 53b. Tab 23a carried by base tab 55 is bent outwardly from base tab 55. Final assembly places end 58 in engagement with tab 23a carried by base tab 55. Tab 23b, not carried by base tab 55, is bent upwardly from panel 20 to support card 70 at its lower edge 74 at an angle suitable for viewing. Preferably, tabs 23a and 23b are parallel to each other. In this configuration, card holder 10 is ready to display card 70. Thus, when configured to support card 70, display member 82 is not bent. Rather, display member 82 merely externally projects outwardly and separate from panel 20.

FIG. 5F depicts card holder 10 assembled to display card 70 As assembled, panel surface 26 of card holder 10 forms card holder front 86 upon which card 70 rests when displayed while edge 74 of card 70 is retained by tab 23b. In the display position depicted in FIG. 5F, display member 82 extends in an upward direction along a similar plane as card holder front 86. As assembled, display member 82 is depicted with edge 82d ready for detaching it.

As used herein, the term “severably scored” includes perforations, cuts or other similar localized breakaway mechanisms. Severably scored lines or seams may pass completely or substantially through panel 20 thereby permitting ready separation of the tab edges. Thus, with regard to FIGS. 5C-5F, severably scored edges 72a, 72b, 72c, 82a, 82b, and 82c are all separable from panel 20 by application of a sufficient force such that it does not induce tearing or localized material failure of the surrounding material. The aforementioned edges are similar to edges 24a-c discussed above and function identically thereto. As used herein, the term “lightly scored” means a scratch or partial cut that does not completely penetrate through the material while facilitating movement or flexing of the panel or tab about a point without the intent of breaking or detaching it from panel 20.

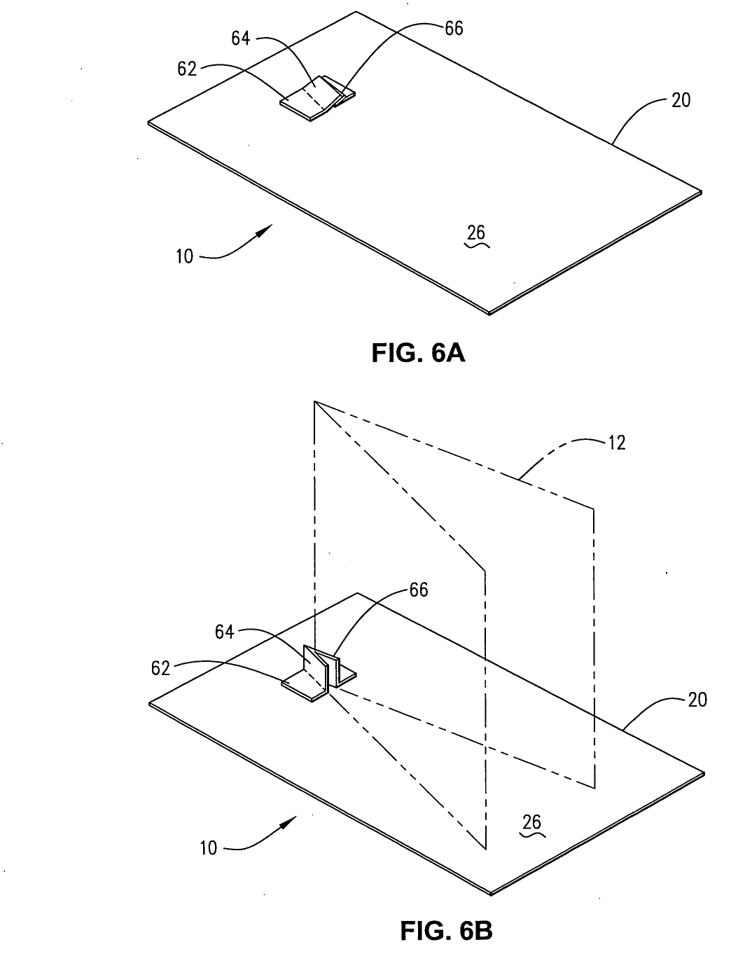

In yet another embodiment, the current invention depicted in FIG. 6A and FIG. 6B, provides a card holder 60 which does not require scoring of panel 20. In the embodiment shown in FIG. 6A, a card supporter 62 is secured to surface 26 of panel 20. Card support 62 is preferably sufficiently flexible to permit folding to a substantially flat position as shown in FIG. 6A thereby permitting mailing of card holder 60 in a conventional envelope. When moved to an upright position as depicted in FIG. 6B, card supporter 62 has a generally V-shaped configuration defined by sidewalls 64 and 66.

As shown in FIG. 6B, greeting card 12 is displayed in book configuration with fold 14 inserted into the V defined by sidewalls 64 and 66. Thus, card supporter 62 provides sufficient stability to enable display of card 12. Card support 62 may be utilized alone or in combination with the embodiments of the current invention depicted in FIGS. 4A, 4B and 4C.

The current invention further provides a method for configuring a greeting card holder 10 from a flat panel 20 of paperboard, plastic or other similar material. According to the method of the current invention, a panel 20 of desired material is cut to a size suitable for displaying the desired greeting card 12. The dimensional size will depend in part on the configuration of card 12. As will be apparent from an examination of FIGS. 1B and 4B, the width and length of card holder 10 will be determined by the dimensions of card 12 and the location/configuration of fold 14.

Following sizing of card holder 10, tabs 22 are severably scored into panel 20. The methods for scoring tabs 22 in paperboard and plastic are well known to those skilled in the art. Although tabs 22 are portrayed in the FIGS. as square or rectangular in shape, it is understood that any shape will work. Preferably, the scoring permits extension of tabs 22 from panel 20 by slight pressure applied with a finger or pencil eraser. Tabs 22 are subsequently positioned in a manner to engage card 12 placed on card holder 10.

As noted above, a stabilizing tab 34 may also be scored into panel 20. If stabilizing tab 34 is provided, it is also extended and positioned to provide further support to card 12.

Once necessary tabs 22 are positioned outwardly from panel 20, greeting card 12 is positioned on card holder 10. Tabs 22 provide sufficient friction to stabilize card 12 reducing the likelihood of card 12 collapsing or falling over.

The above description refers frequently to greeting cards; however, it is understood that card holder 10 of the current invention can be used advantageously to display business cards, card-size advertising plaques, informational signs in stores, unframed decorative cards and so on. The card holder of this invention also offers a unique marketing tool in that it is an inexpensive, disposable, functional and decorative tool for displaying a card and can be sold and/or mailed with the card marketed. The United States Postal Service has defined what the acceptable weight of a first class envelope will cost without purchasing additional postage. Typically, a first class card may be mailed with a single first class stamp if the weight is 1 ounce or less. Although the cards described herein can weigh more than 1 ounce, in most embodiments the combination of card holder 10 should not cause the weight of the combined mailing to exceed a single first class postage stamp. It is understood that it may be preferred to have an embodiment using a material that will exceed the weight of a single first class stamp.

While certain preferred embodiments of the invention have been illustrated and described for purposes of the present disclosure, numerous changes in the arrangement and construction of parts and steps may be made by those skilled in the art, which changes are encompassed within the scope and spirit of the present invention as defined by the appended claims.

What is claimed is:

1. A card holder comprising:
a panel, the panel comprising:
a base tab;
at least two lightly scored seams separated by a display support member;
at least one flexible seam substantially crossing between both edges of the panel;
a first severably scored tab;
wherein the base tab carries a second severably scored tab; and
wherein the display support member extends from the panel substantially at a mid-point on the panel.

2. The card holder of claim 1, wherein a weight of the card holder is less than or equal to a weight of a greeting card to be displayed by the holder and a combined weight is less than equal to a maximum weight established by the United States Postal Service to mail a first class letter with a single first class postage stamp.

3. A card holder comprising:
a flat panel, the panel including a display tab and a base tab, the display tab defined by three severably scored edges, the base tab having a retained edge and carrying a first severably scored tab;
the panel carrying a second severably scored tab;
a first movable joint traversing from a first edge to a second edge of the panel, the joint defining the retained edge of the base tab, wherein the first movable joint separates the second severably scored tab from the base tab; and
a second movable joint and a third movable joint, the second and third movable joints being in linear alignment and partially traversing the panel from the first edge to the second edge wherein the second and third movable joints are separated by a distance corresponding to the width of the display support member.

4. A method of assembling a card holder comprising:
forming a panel, the panel having a base tab, a display member defined by at least one lightly scored or pre-folded seam substantially crossing between the edges of the panel, and at least one severably scored tab;
separating the severably scored tab along at least three edges and bending it in an upward direction;
bending the panel in an upward direction at the lightly scored or pre-folded seam while keeping the base tab substantially flat to a surface;
separating the display support member from the panel along the severably scored edges;
bending the panel in a downward direction about at least two additional lightly scored seams carried by the panel;
separating a severably scored tab carried by the base tab along at least three edges and bending it in an upward direction; and
engaging an end of the panel with the severably scored tab carried by the base tab.
